(19) United States
(12) Patent Application Publication
(10) Pub. No.: US 2026/0250522 A1
(43) Pub. Date: Aug. 27, 2026

(54) POLYMERIC COMPOSITIONS COMPRISING A PLURALITY OF TEXTURED DOMAINS AND METHODS THEREOF

(71) Applicant: Board of Trustees of Michigan State University, East Lansing, MI (US)

(72) Inventors: Caroline SZCZEPANSKI, East Lansing, MI (US); Sabrina CURLEY, East Lansing, MI (US)

(21) Appl. No.: 19/536,743

(22) Filed: Feb. 11, 2026

Related U.S. Application Data
(60) Provisional application No. 63/756,967, filed on Feb. 11, 2025.

(51) Int. Cl. C09D 5/16; C09D 4/06; C09D 7/65; C09D 133/20

(52) U.S. Cl. CPC C09D 5/1668; C09D 4/06; C09D 7/65; C09D 133/20

(57) ABSTRACT

The present disclosure provides various compositions comprising an outer surface comprising a polymeric composition, wherein the outer surface comprises a first domain comprising a first texture property, and wherein the outer surface comprises a second domain comprising a second texture property. For instance, the polymeric composition can be a photopolymer and the polymeric composition can be coated on the outer surface of the composition. Methods of making the compositions are also provided as well as several methods of using the compositions, including water harvesting, fluid transport, separating fluids, and self-cleaning.

### CROSS-REFERENCE TO RELATED APPLICATIONS

This application claims the benefit under 35 U.S.C. § 119(e) of U.S. Provisional Application Ser. No. 63/756,967, filed on Feb. 11, 2025, the entire disclosures of which is incorporated herein by reference.

### BACKGROUND AND SUMMARY

Surface properties, including wettability and adhesion, can be enhanced by incorporating texture on a composition to provide behavior beyond what is possible on an analogous smooth interface. For example, nature presents numerous instances of surfaces decorated with complex textures that impart specific functionality. Often, these natural surfaces incorporate hierarchical textures, such as topographies incorporated to a surface on two or more distinct length-scales. The value of hierarchical texturing is demonstrated by the unique and varied water surface interactions on lotus leaves and rose petals. Lotus leaves have microscale bumps with additional nanoscale rod-like features that enable water to easily flow off the surface and clean the leaf. Rose petals, which also have microscale bumps, are decorated with nanoscale folds that impart parahydrophobic behavior and water droplets cling to the surface.

Although the utility of hierarchical structures is evident from natural examples, engineering complex physical patterning to a surface is not straightforward. Post-modification of a synthesized product, such as etching, is often used to incorporate desired topographies at multiple lengthscales. However, incorporation of these structures in-situ is highly desired in order to reduce costs and ease of forming such compositions.

Distinct and separate mechanisms have resulted in formation of various surface patterns on objects. However, combining multiple mechanisms on a single composition can provide enhanced complexity by increasing the types of topographies that form on compositions.

Accordingly, the present disclosure provides compositions comprising a plurality of surface textures that result in advantageous properties compared to the state of the art. For instance, the presence and concentration of dissolved oxygen (O₂) can impact the concentration of free radicals and tuning radical quenching from O₂ during curing provides certain textured surfaces. Moreover, as shown in FIG. 1, phase separation can also guide surface patterning using photoinduced phase separation (PIPS) and can provide synergistic textured surfaces on the composition.

As described herein, surface texture formation can be tuned by varying inert prepolymer loading as well as by manipulating the kinetics of polymerization through the applied UV light intensity. The resin formulations of the present disclosure comprise compositional gradients enabling two surface roughening mechanisms: O₂ radical quenching and inert-additive PIPS to independently form topographical features. By combining microscale roughness due to O₂ quenching with millimeter scale waves using PIPS, a diverse library of complex surface patterns can be generated for a wide range of functionality. Furthermore, methods of forming compositions as provided herein can utilize multiple mechanisms, including applying light sources and liquid droplets, to enable complex patterned surfaces to form on a composition.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTIONS OF THE DRAWINGS

The detailed description particularly refers to the accompanying figures in which:

FIGS. 1A-1B provide strategies to form topography by generating a mismatch in modulus in photopolymerizable systems. FIG. 1A shows oxygen quenching in which materials have lower crosslinking at the surface because of a decreased reaction rate in this domain caused by quenched radicals yet have higher crosslinking in the bulk where oxygen has not diffused, creating a depth wise gradient in modulus and associated surface roughness. FIG. 1B shows phase separation in which these gradients are not restricted to depth wise directions and can arise from differences in the monomer to polymer shrinkage of compositionally different domains that result from de-mixing (phase separation).

FIG. 2 depicts the chemical structures of species included in resin formulations. Top left to right: acrylonitrile (AN-comonomer) and 1,6 hexanediol diacrylate (HDDA-crosslinker) Shown on the bottom from left to right: poly(methyl methacrylate) (PMMA-inert additive) and 2, 2-dimethoxy-2-phenylacetophenone (DMPA-photoinitiator).

FIG. 3 illustrates the procedure for preparing large area samples which involved the following steps: degassing the resin using N₂, depositing resin onto the petri dish substrate, curing the sample at one of the two UV intensity conditions, followed by applying a matte finish spray paint to aid in microscope imaging.

FIGS. 4A-4B present full area images of the AₐX_{b}P_{c} coatings made in petri dish molds cured at 0.01 W/cm² shown in FIG. 4A and 0.1 W/cm², shown in FIG. 4B. Characterizations were performed on the center area to mitigate influence of perimeter edge effects on the resulting surface topography. Distinct phase separation is indicated by the opaque regions near the circle rim.

FIGS. 5A-5C depict increasing PMMA loading in the A₉₅X₅P_{c} resins which reveals complex surface wrinkling as a result of macroscopic phase separation. The comonomer resins without any PMMA loading (FIG. 5Ai., and FIG. 5Aii.; same as FIG. 7Ai., and FIG. 7Aii.) show dappled texture (e.g. spotted or rounded domains) attributed to gradients in cross-linking throughout the depth of the film. Introduction of PMMA at low loading levels (5 wt %) generates long wavy features alongside the dappled roughness shown for A₉₅X₅P₀. This reveals that the simultaneous phase separation (PIPS) resulting from PMMA introduction results in two mechanisms of wrinkling on a single surface (Combined Mechanisms, shown in FIG. 5Bi. and FIG. 5Bii.). With further additions of PMMA, the PIPS mechanism dominates over other wrinkling mechanisms and thus the surface topography reveals only the long wave features (depicted in FIG. 5Ci. and FIG. 5Cii., PIPS dominated). Respective 2D-FFT results are shown for each image in the upper right corner.

FIGS. 6A-6B show the kinetics of the copolymer resins (e.g., AₐX_{b}P₀) undergoing photopolymerization depend on the amount of crosslinker (e.g., HDDA) present. Here, real-time conversion is gauged by the disappearance of the C═C bond peak at 6170 cm⁻¹ during polymerization (shown in FIG. 6A). Sharp S-shaped curves arise for polymerizations with high crosslinker (HDDA) fractions, consistent with autoacceleration behavior characteristic of free-radical, network polymerizations. As the fraction of crosslinker decreases, linear kinetics dominate, a more steady conversion profile is observed (e.g., A₉₅X₅P₀). These trends as a function of crosslinker content also manifest when comparing the rate of polymerization (Rₚ), obtained by taking the first derivative of the conversion vs. time profiles (shown in FIG. 6B.). With a higher degree of crosslinking, Rₚ is generally greater throughout the reaction period. Furthermore, the maximum rate of polymerization (R_{p,max}, arrows) occurs earlier in the reaction timeline.

FIGS. 7A-7C illustrate that with increasing crosslink density, inherent features transition from textured to smooth in the copolymer resins A₉₅X₅P₀ as shown in FIG. 7Ai., A₉₀X₁₀P₀ as shown in FIG. 7Bi., and A₇₀X₃₀P₀ as shown in FIG. 7Ci., cured at 0.01 W/cm². Surface roughness is apparent at lower crosslinker fractions, but when the crosslinker fraction is increased to 30 wt %, the reaction kinetics hinders the ability of internal stresses to relax, resulting in a smooth surface. This trend is also observed at higher curing intensities (0.1 W/cm², A₉₅X₅P₀ as shown in FIG. 7Aii., A₉₀X₁₀P₀ shown in 7Bii., and A₇₀X₃₀P₀ shown in 7Cii.). In FIG. 7Ci., the small wrinkle patterns were confirmed to be below the sample surface using profilometry, instead occurring at the sample/substrate interface. Respective 2D-FFT results are shown for each image in the upper right corner.

FIGS. 8A-8B depict surface profilometry of comonomer resins (AₐX_{b}P₀) highlights decreased roughness and feature sizes as a function of crosslinking, a trend observed in samples cured at 0.01 W/cm² (shown in FIG. 8A.) compared to 0.1 W/cm² as shown in FIG. 8B., with each sample condition comprising of 12 data points. In both curing conditions, the surface roughness is closely tied to the measured feature wavelength. Additionally, the higher irradiation condition corresponds with a higher degree of roughness (FIG. 8B).

FIG. 9 graphically represents higher water contact angles observed in the roughened surfaces from samples with decreased HDDA wt % loading when cured at 0.01 W/cm². This additional roughness leads to an increase of approximately 20° compared to the smooth surface formed in highly crosslinked conditions. Static water contact angles were measured using a goniometer (Kruss, Drop Shape Analyzer-DSA30), with each sample condition comprising of 4 data points.

FIGS. 10A-10B depict thermal analysis of copolymer networks: AₐX_{b}P₀ at two irradiation intensities (Iₒ=0.01 W/cm² (shown in FIG. 10A.) and 0.1 W/cm² (shown in FIG. 10B.)). Tan (8) data is obtained from the ratio of the polymer's loss modulus (E″) to storage modulus (E′) obtained via 3-point bending testing between temperatures of 50° C. and 200° C. In the high-irradiation scenario, as shown in FIG. 10B, the presence of multiple maxima in the tan (8) profiles indicate that distinct phase domains form during copolymerization of acrylonitrile and 1,6-hexanedioldiacrylate. These multiple domains correspond with visible opacity of the copolymer networks. Quantitative data of T_{g} position and FWHM can be found in Tables 5 and 6.

FIGS. 11A-11C show that in highly crosslinked resin samples, PMMA induces surface wrinkling via PIPS to samples that would otherwise be Kinetically Trapped. The comonomer resins shown in FIG. 11Ai. and FIG. 11Aii. (same as FIG. 7Ci., and FIG. 7Cii.) are smooth with minimal features. Large wavy wrinkles are present with PMMA additions of 5 wt % (shown in FIG. 11Bi. and FIG. 11Bii.) and 10 wt % PMMA (shown in FIG. 11Ci. and FIG. 11Cii.). Respective 2D-FFT results are shown for each image in the upper right corner.

FIGS. 12A-12D depict increased PMMA loading corresponds to larger features and increased roughness in PIPS dominated resins, with each sample condition comprising of twelve data points. Comparing A₉₅X₅P_{c} formulations cured at 0.01 W/cm² (shown in FIG. 12A) and 0.1 W/cm² as shown in FIG. 12B, the PMMA induced wrinkles had a similar feature wavelength and roughnesses regardless of UV condition. While the pure comonomer had differences in feature size as a result of UV intensity, this did not affect the emergence of PIPS wrinkling. The higher crosslinked A₇₀X₃₀P_{c} formulation cured at 0.01 W/cm² (illustrated in FIG. 12C) and 0.1 W/cm² (shown in FIG. 12D) went from a relatively smooth surface to having large wrinkles with the addition of PMMA. In this case, larger features with more variance in their wavelength were observed at the low UV condition. The wrinkles in A₇₀X₃₀P₅ and A₇₀X₃₀P₁₀ had wavelengths of over 1 mm, breaking into the macroscale compared to features observed in the A₇₀X₃₀P₀ counterparts.

FIG. 13 shows a comparison between the ratio between VA and HDDA network regions against PDMS signal intensity.

FIG. 14 shows the various polymeric surfaces formed via application of water droplets applied during the UV curing process.

FIG. 15 shows roughness values (Ra) were increased an order of magnitude between formulations with increased resin depth.

FIG. 16 shows the setup of sample evaluation via the collected water from humidifier mist.

FIGS. 17 and 18 demonstrate that samples that possessed hydrophilic patterning collected more water compared to pure resin counterparts.

FIG. 19 shows that the plurality of surface textures present on the polymeric composition is easily cleanable after exposure to dirt and mud.

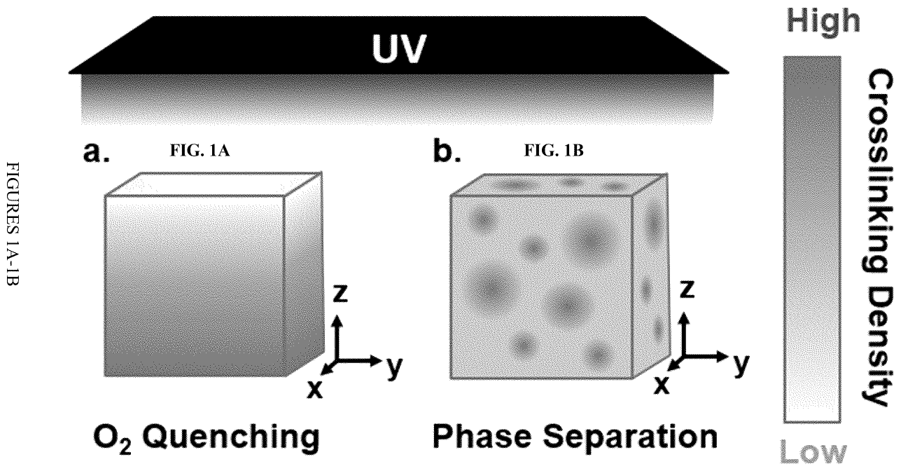

### DETAILED DESCRIPTION

Various embodiments of the invention are described herein as follows. In an illustrative aspect, a composition comprising an outer surface comprising a polymeric composition is provided, wherein the outer surface comprises a first domain comprising a first texture property, and wherein the outer surface comprises a second domain comprising a second texture property.

In an embodiment, the polymeric composition is a photopolymer. Generally, a photopolymer refers to a polymer that changes properties when exposed to light, for instance in the ultraviolet or visible region of the electromagnetic spectrum.

In an embodiment, the polymeric composition is coated on the outer surface of the composition. For example, the coating can be a thin layer on the outer surface of the composition or a thick layer on the outer surface of the composition. Alternatively, the entire or the majority of the composition can be a polymeric composition.

In an embodiment, the first domain is hydrophilic. In an embodiment, the second domain is hydrophobic.

In an embodiment, the first texture property comprises surface roughness on the outer surface. Surface roughness can be either visible to the naked eye or not visible to the naked eye. In an embodiment, the surface roughness is present on a microscale level.

Further, the surface roughness can be quantified according to methods known in the art. In an embodiment, the surface roughness is present at an arithmetic roughness (Ra) value between about 5 μm and 100 μm. In an embodiment, the surface roughness is present at an arithmetic roughness (Ra) value between about 5 μm and 10 μm. In an embodiment, the surface roughness is present at an arithmetic roughness (Ra) value between about 10 μm and 20 μm. In an embodiment, the surface roughness is present at an arithmetic roughness (Ra) value between about 20 μm and 30 μm. In an embodiment, the surface roughness is present at an arithmetic roughness (Ra) value between about 30 μm and 40 μm. In an embodiment, the surface roughness is present at an arithmetic roughness (Ra) value between about 40 μm and 50 μm. In an embodiment, the surface roughness is present at an arithmetic roughness (Ra) value between about 50 μm and 60 μm. In an embodiment, the surface roughness is present at an arithmetic roughness (Ra) value between about 60 μm and 70 μm. In an embodiment, the surface roughness is present at an arithmetic roughness (Ra) value between about 70 μm and 80 μm. In an embodiment, the surface roughness is present at an arithmetic roughness (Ra) value between about 80 μm and 90 μm. In an embodiment, the surface roughness is present at an arithmetic roughness (Ra) value between about 90 μm and 100 μm.

In an embodiment, the second texture property comprises a plurality of surface waves on the outer surface. Surface waves can be either visible to the naked eye or not visible to the naked eye. In an embodiment, the plurality of surface waves is present on a millimeter scale level.

Further, the surface waves can be quantified according to methods known in the art. In an embodiment, the plurality of surface waves comprise a wavelength between about 0.5 mm and about 1 mm. In an embodiment, the plurality of surface waves comprise a wavelength between about 1 mm and about 1.5 mm. In an embodiment, the plurality of surface waves comprise a wavelength between about 1.5 mm and about 2 mm. In an embodiment, the plurality of surface waves comprise a wavelength less than about 0.5 mm. In an embodiment, the plurality of surface waves comprise a wavelength less than about 1.0 mm. In an embodiment, the plurality of surface waves comprise a wavelength less than about 1.5 mm. In an embodiment, the plurality of surface waves comprise a wavelength less than about 2.0 mm.

In an embodiment, the first texture property is formed via liquid droplet guided domain formation. In an embodiment, the liquid is water. Liquid droplet guided domain formation can be utilized according to processes described herein or proceeding according to methods in the art.

In an embodiment, the second texture property is formed via oxygen radical quenching. Oxygen radical quenching can be utilized according to processes described herein or proceeding according to methods in the art.

In an embodiment, the second texture property is formed via photoinduced phase separation (PIPS). PIPS can be utilized according to processes described herein or proceeding according to methods in the art.

In an embodiment, the polymeric composition comprises a monomer and a crosslinker. In an embodiment, the monomer comprises one radically polymerizable group. In an embodiment, the monomer is acrylonitrile. In an embodiment, the monomer is vinyl acetate. In an embodiment, the monomer is vinyl butyl ether. In an embodiment, the monomer is methyl methacrylate. In an embodiment, the monomer is methacrylic acid. In an embodiment, the monomer is butyl acrylate. In an embodiment, the monomer is butyl methacrylate. In an embodiment, the monomer is ethyl methacrylate.

In an embodiment, the crosslinker has a molecular weight less than about 500 g/mol. In an embodiment, the crosslinker comprises two radically polymerizable groups. In an embodiment, the crosslinker is 1,6 hexanediol diacrylate (HDDA). In an embodiment, the crosslinker is ethylene glycol diacrylate (EGDA). In an embodiment, the crosslinker is triethylene glycol diacrylate (TEGDA). In an embodiment, the crosslinker is 1,4 butane diol diacrylate (BDDA). In an embodiment, the crosslinker is diethylene glycol diacrylate (DEGDA).

In an embodiment, the monomer is present in the polymeric composition at between about 65% to about 95% (wt. %). In an embodiment, the monomer is present in the polymeric composition at between about 70% to about 75% (wt. %). In an embodiment, the monomer is present in the polymeric composition at between about 75% to about 80% (wt. %). In an embodiment, the monomer is present in the polymeric composition at between about 80% to about 85% (wt. %). In an embodiment, the monomer is present in the polymeric composition at between about 85% to about 90% (wt. %). In an embodiment, the monomer is present in the polymeric composition at between about 90% to about 95% (wt. %).

In an embodiment, the crosslinker is present in the polymeric composition at between about 2.5% to about 35% (wt. %). In an embodiment, the crosslinker is present in the polymeric composition at between about 2.5% to about 5% (wt. %). In an embodiment, the crosslinker is present in the polymeric composition at between about 5% to about 10% (wt. %). In an embodiment, the crosslinker is present in the polymeric composition at between about 10% to about 15% (wt. %). In an embodiment, the crosslinker is present in the polymeric composition at between about 15% to about 20% (wt. %). In an embodiment, the crosslinker is present in the polymeric composition at between about 20% to about 25% (wt. %). In an embodiment, the crosslinker is present in the polymeric composition at between about 25% to about 30% (wt. %). In an embodiment, the crosslinker is present in the polymeric composition at between about 30% to about 35% (wt. %).

In an embodiment, the polymeric composition further comprises an inert additive. In an embodiment, the inert additive is hydrophobic. In an embodiment, the inert additive has a contact angle of greater than about 90°.

In an embodiment, the inert additive is poly(methyl methacrylate) (PMMA). In an embodiment, the inert additive is poly(dimethyl siloxane) (PDMS). In an embodiment, the inert additive is poly(butyl methacrylate) (PBMA).

In an embodiment, the inert additive is present in the polymeric composition at between about 2.5% to about 15% (wt. %). In an embodiment, the inert additive is present in the polymeric composition at between about 2.5% to about 5% (wt. %). In an embodiment, the inert additive is present in the polymeric composition at between about 5% to about 7.5% (wt. %). In an embodiment, the inert additive is present in the polymeric composition at between about 7.5% to about 10% (wt. %). In an embodiment, the inert additive is present in the polymeric composition at between about 10% to about 12.5% (wt. %). In an embodiment, the inert additive is present in the polymeric composition at between about 12.5% to about 15% (wt. %).

As utilized herein, the monomer and the inert additive generally have differing surface energies from one another at the end of the reaction process. For instance, the differing surface energies can be sufficient enough to be guided into a macro-phase separation technique using interfacial energy differences. In one specific example, liquid droplets and the air interface of the coating can provide the difference in interfacial energy.

In some embodiments, the selection of the monomer and the inert additive can proceed by utilizing a hydrophilic monomer and a hydrophobic inert additive so that the components have compatible solubility with one another. For instance, the solubility can be analyzed numerically with Hansen solubility parameters such that the calculated relative energy difference between the two compounds is less than about 1. Moreover, the polymerized analog of the monomer and the inert additive could have partially- to completely-incompatible solubilities with one another (e.g., defined numerically with Hansen solubility parameters so that the representative spheres in Hansen parameter space for the two compounds have a volume overlap with one another approximately 40% or less).

In an embodiment, the polymeric composition further comprises a photo initiator. In an embodiment, the photo initiator is 2,2-dimethoxy-2-phenylacetophenone (DMPA). In an embodiment, the photo initiator is (2,4,6-Trimethylbenzoyl)-bis(4-methylphenyl)phosphine oxide (TMO).

In an embodiment, the photo initiator is present in the polymeric composition at between about 0.5% to about 5% (wt. %). In an embodiment, the photo initiator is present in the polymeric composition at between about 0.5% to about 1% (wt. %). In an embodiment, the photo initiator is present in the polymeric composition at between about 1% to about 1.5% (wt. %). In an embodiment, the photo initiator is present in the polymeric composition at between about 1.5% to about 2% (wt. %). In an embodiment, the photo initiator is present in the polymeric composition at between about 2% to about 2.5% (wt. %). In an embodiment, the photo initiator is present in the polymeric composition at between about 2.5% to about 3% (wt. %). In an embodiment, the photo initiator is present in the polymeric composition at between about 3% to about 3.5% (wt. %). In an embodiment, the photo initiator is present in the polymeric composition at between about 3.5% to about 4% (wt. %). In an embodiment, the photo initiator is present in the polymeric composition at between about 4% to about 4.5% (wt. %). In an embodiment, the photo initiator is present in the polymeric composition at between about 4.5% to about 5% (wt. %).

In an illustrative aspect, a method of forming a plurality of domains on an outer surface of a composition is provided. The method comprises the steps of i) obtaining the composition, wherein the outer surface of the composition comprises a polymeric composition, ii) applying a light source to the outer surface of the composition, and iii) applying a plurality of liquid droplets to the outer surface of the composition, wherein steps ii) and iii) form the plurality of domains on the outer surface of the composition.

In an embodiment, the plurality of domains comprises a first domain and a second domain. In an embodiment, the first domain is hydrophilic. In an embodiment, the second domain is hydrophobic.

In an embodiment, the first domain comprises a first texture property. In an embodiment, the first texture property comprises surface roughness on the outer surface. In an embodiment, the surface roughness is present on a microscale level.

In an embodiment, the second domain comprises a second texture property. In an embodiment, the second texture property comprises a plurality of surface waves on the outer surface. In an embodiment, the plurality of surface waves is present on a millimeter scale level.

In an embodiment, the plurality of surface waves comprise a wavelength between about 0.5 mm and about 1 mm. In an embodiment, the plurality of surface waves comprise a wavelength between about 1 mm and about 1.5 mm. In an embodiment, the plurality of surface waves comprise a wavelength between about 1.5 mm and about 2 mm.

In an embodiment, the plurality of surface waves comprise a wavelength less than about 0.5 mm. In an embodiment, the plurality of surface waves comprise a wavelength less than about 1.0 mm. In an embodiment, the plurality of surface waves comprise a wavelength less than about 1.5 mm. In an embodiment, the plurality of surface waves comprise a wavelength less than about 2.0 mm.

In an embodiment, the first domain is formed by step ii). In an embodiment, the first domain is formed by step iii). In an embodiment, the second domain is formed by step ii). In an embodiment, the second domain is formed by step iii).

The previously described embodiments of the composition are applicable to the method of forming a plurality of domains on an outer surface as described herein.

In an illustrative aspect, a further method of forming a plurality of domains on an outer surface of a composition is provided. The method comprises the steps of i) obtaining the composition, wherein the outer surface of the composition comprises a polymeric composition, and ii) applying a light source to the outer surface of the composition, wherein step ii) forms the plurality of domains on the outer surface of the composition.

In an embodiment, the plurality of domains comprises a first domain and a second domain. In an embodiment, the first domain is hydrophilic. In an embodiment, the second domain is hydrophobic.

In an embodiment, the first domain comprises a first texture property. In an embodiment, the first texture property comprises surface roughness on the outer surface. In an embodiment, the surface roughness is present on a microscale level.

In an embodiment, the second domain comprises a second texture property. In an embodiment, the second texture property comprises a plurality of surface waves on the outer surface. In an embodiment, the plurality of surface waves is present on a millimeter scale level.

In an embodiment, the plurality of surface waves comprise a wavelength between about 0.5 mm and about 1 mm. In an embodiment, the plurality of surface waves comprise a wavelength between about 1 mm and about 1.5 mm. In an embodiment, the plurality of surface waves comprise a wavelength between about 1.5 mm and about 2 mm.

In an embodiment, the plurality of surface waves comprise a wavelength less than about 0.5 mm. In an embodiment, the plurality of surface waves comprise a wavelength less than about 1.0 mm. In an embodiment, the plurality of surface waves comprise a wavelength less than about 1.5 mm. In an embodiment, the plurality of surface waves comprise a wavelength less than about 2.0 mm.

The previously described embodiments of the composition are applicable to the method of forming a plurality of domains on an outer surface as described herein.

The compositions of the present disclosure can be utilized for several purposes to provide improvements in the art. For example, the compositions can be utilized in methods to perform water harvesting, for instance water harvesting from fog. Further, the compositions can be used in methods for fluid transport, including processes for guided fluid transport. In addition, methods for separating fluids can include use of the compositions as well as coatings that can advantageously be self-cleaning.

### EXAMPLES

### Example 1

### Exemplary Materials

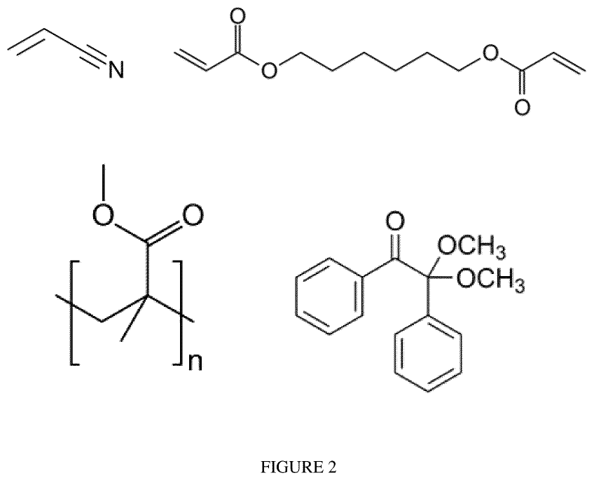

Co-monomer formulations were comprised of acrylonitrile monomer (AN, Sigma Aldrich) and 1,6 hexanediol diacrylate (HDDA, Sigma Aldrich), which acts as a cross-linker (FIG. 2). In select resin formulations, poly(methyl methacrylate) (PMMA; M_{w}=120,000 g/mol, Sigma Aldrich) was incorporated as an inert polymer additive that promotes phase separation during polymerization. In all formulations, 2,2-dimethoxy-2-phenylacetophenone (DMPA, Sigma Aldrich) was employed as a photoinitiator (0.5 wt %). All chemicals were used as received and without further purification.

### Example 2

### Resin Preparation

Two classes of resins are described herein: copolymer resins including AN and HDDA along with those PMMA-modified resins (e.g., containing AN, HDDA and PMMA). Copolymer resins were investigated as controls and included varying ratios (wt %) of AN: HDDA, with HDDA ranging from 5 wt % to 50 wt %. To increase the free energy in the polymerizing system and promote phase separation, PMMA was incorporated at levels ranging from 5 wt % to 10 wt %. The loading levels are established to be sufficient to promote phase separation, while having only a modest increase in resin viscosity thus enabling relatively straightforward coating application for the examples herein.

For mechanical and kinetic characterization, samples were cured as rectangles inside an enclosed mold, the loading of DMPA was held at 0.5 wt % relative to the combined weight of the other species (Table 1), while for samples cured as large area coatings with the surface exposed to the air, the loading of DMPA was held at 5 wt % relative to the combined weight of the other species to account for increased O₂ exposure (Table 2). This nesting of the wt % ratios results in the resin notation of [DMPA]_{0.5}([PMMA]ₓ([HDDA]_{y}[AN]_{(1-y)})₍₁₋ₓ₎)_{99.5} and [DMPA]₅([PMMA]ₓ([HDDA]_{y}[AN]_{(1-y)})₍₁₋ₓ₎)₉₅, with x=0.00, 0.05, 0.10, 0.20 and y=0.05, 0.10, 0.20, 0.30, 0.40, 0.50, 1.0.

For ease of reference, samples will be referred to as AₐX_{b}P_{c}, where A corresponds to AN content, X corresponds to HDDA content, and P to PMMA content. The subscript associated with each term indicates the wt % of the constituent, where a and b are the wt % values of AN and HDDA relative to one another within the comonomer resin, respectively, and c is the wt % of PMMA relative to the whole resin sans DMPA.

TABLE 1
Full Compositions of Resins with Nomenclature -
Closed Mold Formulations

| | AN | HDDA | PMMA | DMPA |
|---|---|---|---|---|
| | (wt %) | (wt %) | (wt %) | (wt %) |
| A₉₅X₅P₀ | 94.52 | 4.98 | — | 0.50 |
| A₉₀X₁₀P₀ | 89.55 | 9.95 | — | 0.50 |
| A₇₀X₃₀P₀ | 69.65 | 29.85 | — | 0.50 |

TABLE 2
Full Compositions of Resins with Nomenclature -
Coating Formulations

| | AN | HDDA | PMMA | DMPA |
|---|---|---|---|---|
| | (wt %) | (wt %) | (wt %) | (wt %) |
| A₉₅X₅P₀ | 90.25 | 4.75 | — | 5.00 |
| A₉₀X₁₀P₀ | 85.50 | 9.50 | — | 5.00 |
| A₇₀X₃₀P₀ | 66.50 | 28.50 | — | 5.00 |
| A₉₅X₅P₅ | 85.74 | 4.51 | 4.75 | 5.00 |
| A₉₅X₅P₁₀ | 81.22 | 4.28 | 9.50 | 5.00 |
| A₇₀X₃₀P₅ | 63.18 | 27.08 | 4.75 | 5.00 |
| A₇₀X₃₀P₁₀ | 59.85 | 25.65 | 9.50 | 5.00 |

To formulate resins, DMPA was first massed in a glass vial, and if needed PMMA was also added to the same vial. These solids were then allowed to completely dissolve in the appropriate mass of AN and HDDA following the resin formulation. Haziness in the solution was not observed for any of the samples in the monomer state, indicating good mixing and macroscopic miscibility. After magnetic stirring for 30 minutes at ambient temperature, resins were degassed via N₂ bubbling for 10 minutes prior to photopolymerization to eliminate oxygen inhibition effects.

### Large Area Surface Photopolymerization

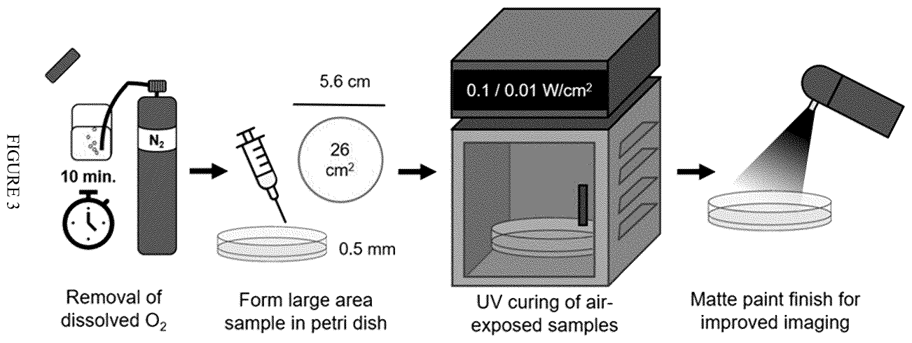

Polystyrene petri dishes with a diameter of 5.2 cm were used as substrates for large area samples. 1.1 mL of resin was deposited into the petri dish using a syringe, resulting in a uniform coating area of 26 cm² and initial resin height of 0.5 mm (FIG. 3). Samples were cured using a 365 nm UV lamp (UVitron, Intelliry 600) with light intensity (Iₒ) at the sample interface recorded using a handheld radiometer (Excelitas, OmiCure R2000 with Cure Site Detector attachment). Exposure varied based on curing intensity, with 5 minutes employed for Iₒ=0.1 W/cm² and 10 minutes for Iₒ=0.01 W/cm². The chosen light intensities were informed by prior work as well as related studies which confirm that an order of magnitude variation in irradiation exposure is significant to manipulating phase morphology via PIPS. The exposure times were determined by observing that the reaction kinetics plateaued at these times in previous FTIR characterizations of AN: HDDA resins without the addition of PMMA.

### Example 3

### Bulk Rectangle Photopolymerization

To investigate mesoscopic phase separation behavior using mechanical testing, rectangular samples from the same resins used as coatings from Example 1, Large Area Surface Photopolymerization were made. In brief, 1 mL of the desired formulation was injected into a rectangular mold comprising glass slides (two glass substrates with glass spacers), creating samples with approximate dimensions of 10 mm×25 mm×2 mm. The glass mold was clamped together to prevent delamination. These samples were also cured using the UVitron, Intelliry 600 UV lamp in the same way as discussed above. Given the interaction between the glass slides used here and incoming UV light, an 8% reduction in UV intensity was recorded when measured with a glass slide on top of the radiometer instrument. This difference is still adequate for inferring kinetic behavior between the specific resin formulation variations.

### Example 4

### Surface Profilometry

Polymerized surfaces were characterized using optical profilometry and imaging (Keyence, VHX-700). Samples were coated with a black matte spray paint (Krylon COLORmaxx Paint+Primer Flat Black) to combat any transparency and/or gloss that would otherwise interfere with the optical profilometry measurements. The application of spray paint was done after all other characterizations and thus does not impact other reported data. Furthermore, the application time was consistent across samples so the applied thickness was uniform. 12 line traces were taken from the generated surface maps for each sample using ImageJ, allowing for calculation of average the amplitude and wavelength. Surface roughness was calculated using the equation for arithmetic roughness following standard ASME B46.1, where Ra is the arithmetic average roughness, L is the scan length, Y (X) is the sample surface height as a function of X, the scan length, Ŷ is the average sample surface height, and Nis the number of individual data points within the whole scan length:

$${R}_{a} = \frac{1}{L} {\int }_{0}^{L} \vert Y ( X ) - \overline{Y} \vert dX \approx \frac{1}{N} {\sum }_{i = 1}^{N} \vert {Y}_{i} - \overline{Y} \vert$$

For additional wrinkle characterization, two-dimensional Fast Fourier Transform (2DFFT) was performed on the collected microscope images using ImageJ. Within each image, a representative square area was selected and used to construct the 2D-FFT representations.

### Example 5

### Real Time Fourier-Transform Infrared Spectroscopy (FT-IR) Analysis

Real time Fourier-Transform Infrared spectroscopy (FTIR, ThermoNicolet, Nicolet iS50) was employed to evaluate the time-dependent polymerization kinetics of select formulations. Samples were injected into a rectangular mold of glass slides with a glass spacer 0.1 mm designed to limit atmosphere exposure during testing.

A UV light source (EFOS Ultracure 100ss Plus, λ~320-500 nm) equipped with a flexible light guide was directed to irradiate the sample area within the FTIR chamber (Iₒ=0.01 W/cm² measured at sample surface), enabling simultaneous UV exposure and real-time collection of FTIR spectra. All samples were angled to ensure that the incoming UV light was perpendicular to the specimen surface while maintaining transmittance of the IR beam. This was done to mitigate the cosine error associated with light intensity experienced by non-perpendicular surfaces, where the intensity at the surface decays following a Lambertian function with increase in the incident angle. Real-time conversion curves were generated by monitoring the integral area between 6100 cm⁻¹ and 6240 cm⁻¹, corresponding to the C═C vinyl peak at 6170 cm⁻¹.

Thermo-mechanical properties of polymerized specimens were assessed using a Dynamic Mechanical Analyzer (DMA, TA Instruments, Discovery DMA800). Samples were measured in a three-point-bending configuration, with a 15 mm gap between supports. A temperature ramp of 5.0° C./min was employed to scan over a range of 20° C. to 200° C. A preload force of 0.01 N was selected, with 20.0 μm amplitude and 1.0 Hz frequency used during the sample run. To ensure that residual, unreacted monomer in the photocured samples did not influence the experiments, all specimens were annealed for 1 hour at 150° C. prior to analysis. The annealing temperatures were chosen based on the reported T_{g} of poly(acrylonitrile) in the range of 75° C. to 105° C.

### Example 6

### Multiple Mechanisms Contributing to Topographies in PIPS Resins

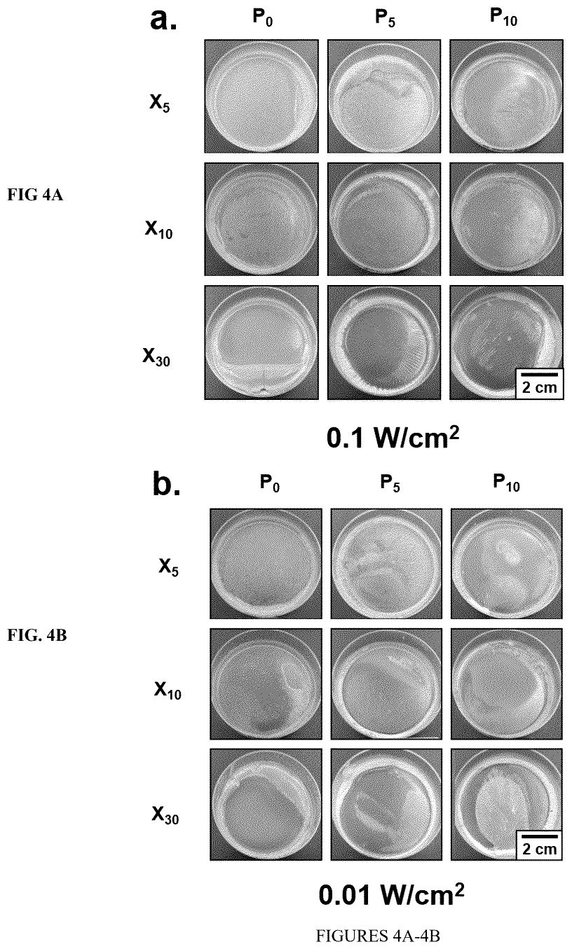

To capture macroscale wrinkling features in phase separating resins, petri dishes (d=5.2 cm) were used as curing substrates for the acrylonitrile, 1,6 hexanediol diacrylate, poly(methyl methacrylate) (denoted as AₐX_{b}P_{c}) family of resins as pictured in FIG. 3. Success with using petri dishes in this fashion has been demonstrated. The 5.2 cm diameter size was selected so that a large region of surface features at the center of the dish could be studied without the influence of edge effects. Furthermore, the dimensions of this substrate allowed for relatively thick coatings (~0.5 mm), thus minimizing any influences of the substrate itself on surface wrinkling behavior (FIG. 4A-FIG. 4B). These considerations enable the resultant surface topography to be accurately ascribed to the photopolymerization phase separation behavior.

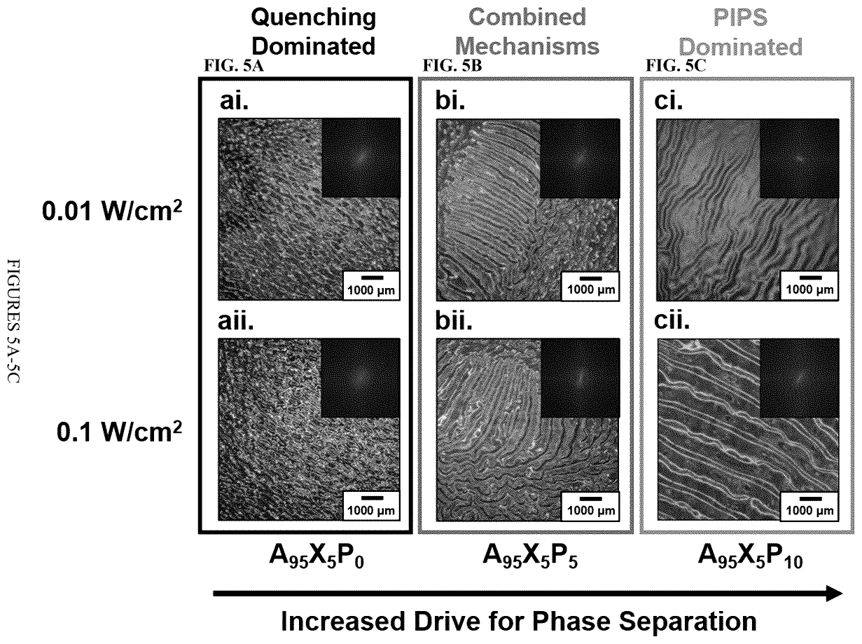

In an open-mold sample, like the petri dish setup used here, the available free interface functions to dissipate stress formation, and by doing so, the topography of the free surface changes depending on the phase morphology underneath. Taking resins with a relatively low crosslinker fraction (e.g., 5 wt % HDDA) as an example, a range of topographies are observed after photopolymerization with an exposed interface (FIG. 5A-FIG. 5C). These topographies arise as PMMA loading and irradiation intensity are varied. These two parameters influence phase behavior and thus enable precise control over the final topographic patterns of each sample.

### Quenching Dominated Samples

The copolymer control formulation without PMMA (A₉₅X₅P₀) yields a uniform, dimple-like roughness (FIG. 5Ai., FIG. 5Aii.). This topography is further visualized using 2D-FFT analysis, where the signal displays a favored orientation with a broad halo. Given that this resin is solely a copolymer matrix, this topography is dominated by the formation of crosslinked networks impacted by oxygen species radical scavenging (e.g., Quenching Dominated). As discussed earlier, having a depth-wise gradient of radical quenching due to exposure to the surrounding air, crosslink density also varies throughout the depth of the coating, leading to the observed topography. This dimple-like roughness possesses a slight orientation and is consistent across the two curing conditions employed (Iₒ=0.01 W/cm² and Iₒ=0.1 W/cm²).

Combined Mechanisms: Simultaneous Contributions from Quenching and PIPS

The addition of PMMA (e.g, A₉₅X₅P₅), and thus inducing macroscopic phase separation during polymerization, results in a secondary topography (FIG. 5Bi., FIG. 5Bii.). Specifically, more discrete waves are shown in combination with the dimple roughness previously observed for the pure comonomer resin (e.g., Combined Mechanisms, FIG. 5A-FIG. 5C). This is reflected in the 2D-FFT analysis, where the signal displays a stronger and more crisp favored orientation with a reduction in the broad halo. The long waves span several millimeters in length, visible to the naked eye. Both the dimple and wave pattern types are equally present across the A₉₅X₅P₅ sample surface area, with the wave alignment predominantly perpendicular to the orientation of the dimple topography.

### PIPS Dominated Samples

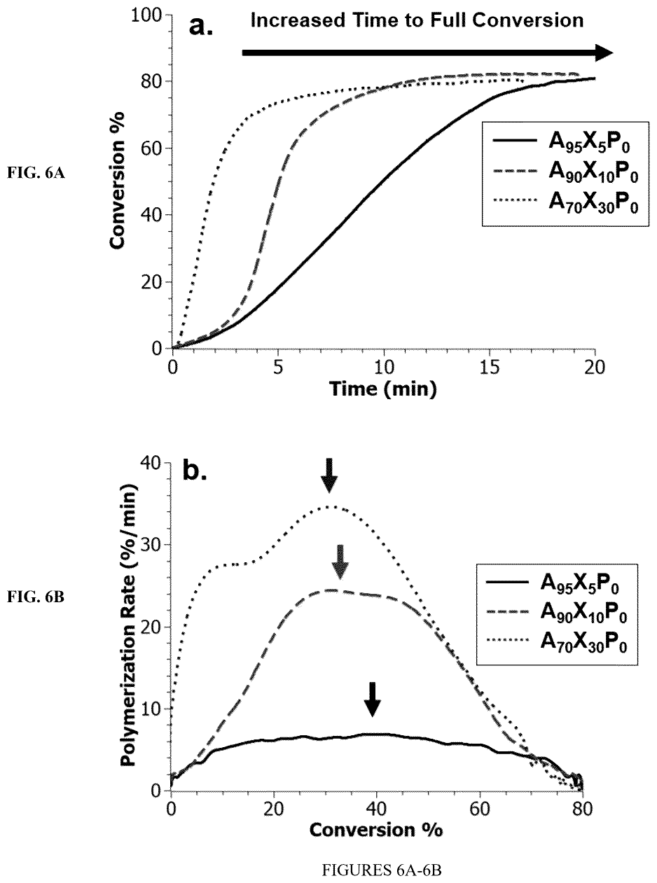

Further increases in the PMMA loading (10 wt %) result in enlarged discrete wave features, which then become the dominant surface topography, with the 2D-FFT analysis showing great reduction in the broad halo, leaving only the strong crisp orientation line (FIG. 6Ci., FIG. 6Cii., PIPS Dominated). Given previous characterization of this resin system when polymerized in bulk, it was expected that both nanoscale (70-100 nm) and microscale phase domains form during polymerization. However, due to geometric constraints of the resulting topographies, features on the nanometer scale were not explored in depth within this study.

In the low irradiation condition of the PIPS Dominated coatings, the smaller dimple features present in the copolymer control are completely eliminated, while there are still some traces of this patterning in the high irradiation condition. This indicates that different styles of patterning can be tuned between dappled roughness (e.g. spotted or rounded domains) and concrete waves via the level of PMMA loading and irradiation intensity. Here, the fraction of PMMA acts as a lever for PIPS activation, with higher PMMA loading corresponding to an increase in the system's Gibb's free energy of mixing (ΔG^{mix}) during polymerization. This reduction in ΔG^{mix} arises as both the miscibility between developing polymer species decreases, as well as availability of macromolecular conformational states, which has been studied for this resin system previously and has also been explored in related phase-separating polymerizations. Furthermore, the addition of PMMA alters the viscosity of the polymerizing resin and thus the reaction kinetics. Specifically, the increased viscosity with PMMA loading results in a slower polymerization rate, which can benefit phase separation by enhancing the time available for diffusion of immiscible domains. This explains why at higher PMMA loadings (e.g., 10 wt %) the topography is PIPS Dominated. Lastly, this timescale for diffusion of phase domains and potential coalescence is altered via irradiation intensity, and thus explains the differences between PIPS Dominated samples cured at 0.1 and 0.01 W/cm². It is also likely that these different irradiation intensities correspond to different mechanisms of phase separation (e.g. Nucleation and Growth vs. Spinodal Decomposition) which further supports the claim for distinct phase morphologies at these conditions.

### Example 7

### Influence of Network Cross-Linking on the Quenching Mechanism

Given the complex surface topographies observed in FIG. 5A-FIG. 5C, it is desirable to parse out individual factors contributing to the final surface topography. Examining comonomer resins without any PMMA additions provides a baseline to identify relevant parameters of the Quenching mechanism and associated topographical texturing in the absence of macroscopic phase separation.

Toward this end, real-time kinetics of the AN and HDDA comonomer resins varying the cross-linker fraction (HDDA) were characterized using FT-IR spectrometry (FIG. 6A-FIG. 6B). In these experiments, a consistent irradiation intensity (Iₒ) of 0.01 W/cm² was employed, as above this intensity the polymerization proceeded too rapidly to be resolved using the spectrometer. In all formulations, the limiting conversion from ambient photopolymerization was ~80% (FIG. 6A). As the fraction of cross-linker (HDDA) decreases, the time to reach limiting conversion increases (black arrow, FIG. 6A). Additionally, in lower HDDA fraction formulations (i.e., reduced cross-linking) the reaction kinetics transition to linear conversion behavior, e.g. conversion increases linearly with time indicative of a relatively constant rate of polymerization (Rₚ). The variation in reaction kinetics as a function of HDDA fraction is further illustrated when plotting the polymerization rate (Rₚ) as a function of conversion. Rₚ was obtained by taking the first derivative of the conversion versus time data. Like limiting conversion, the maximum rate achieved during the polymerization process (R_{p,max}) also decreased with a decreasing HDDA fraction (arrows, FIG. 6B). This decreased R_{p,max}, along with a longer delay (e.g., the extent of conversion) until reaching R_{p,max} indicates that there is more time for molecular rearrangements and potential phase diffusion prior to critical reaction benchmarks such as gelation and/or vitrification, which transition the system to a rubbery or glassy state where rearrangements and diffusion are significantly hindered. For example, in the 30 wt % HDDA formulations (A₇₀X₃₀P₀), the formation of a densely cross-linked network occurs so rapidly that other chemical components become immobile via high viscosity earlier than other formulations probed here.

### Kinetically Trapped Samples

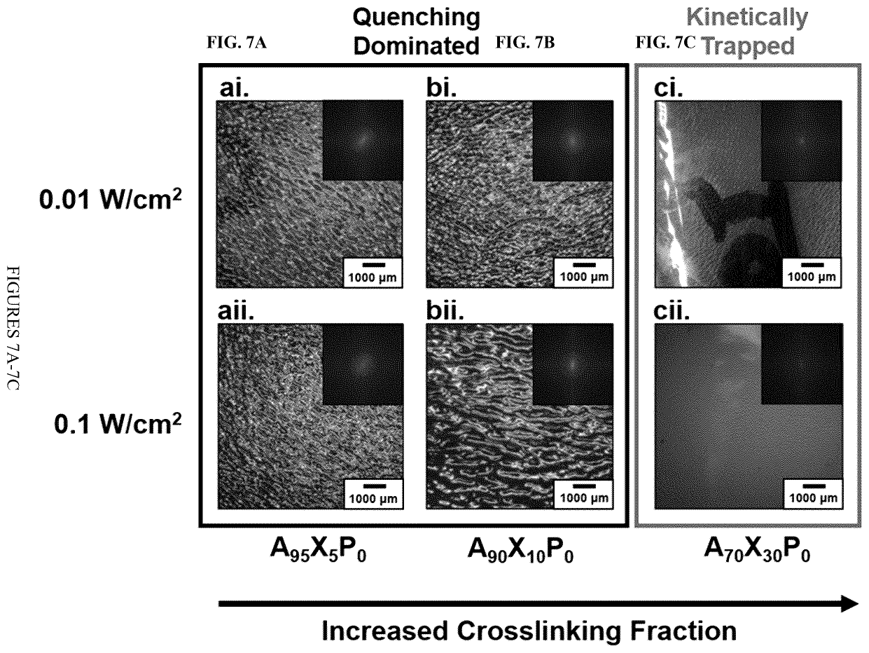

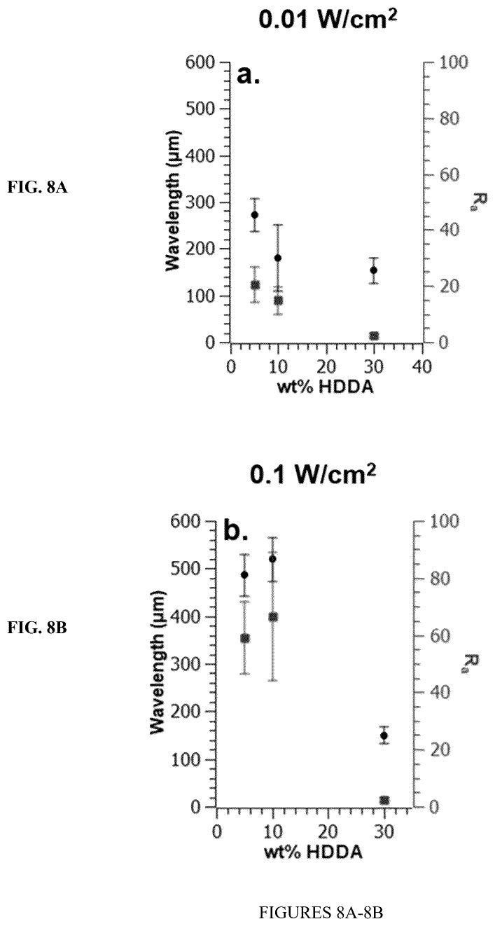

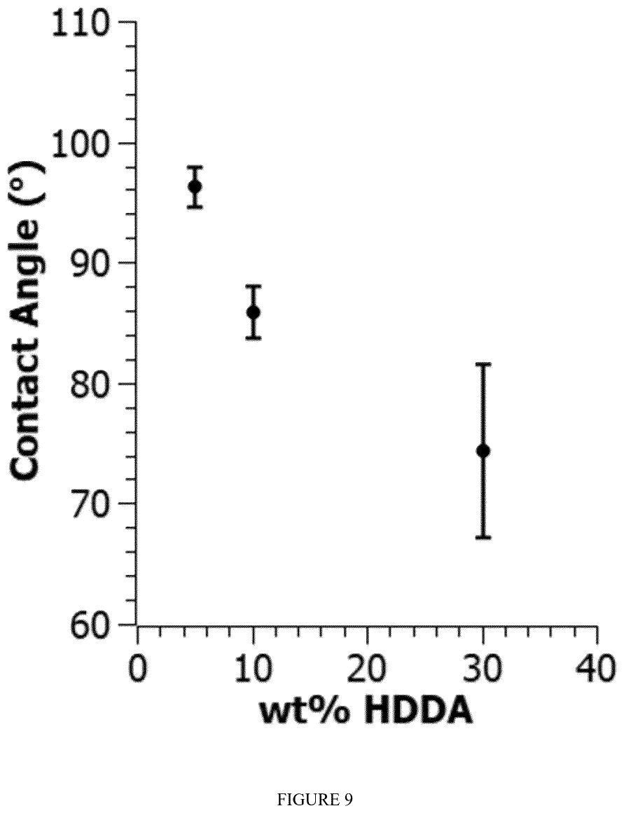

The influence of the kinetic trends as a function of cross-linker in FIG. 6A-FIG. 6B is reflected in the topography that evolves in the copolymer resins (e.g., AₐX_{b}P₀ resins in FIG. 7A-FIG. 7C). Here, increased cross-linker fractions result in less textured surfaces for both of the irradiation conditions, captured with 2D-FFT analysis as the indications of topography orientation are greatly diminished in the A₇₀X₃₀P₀ surfaces. Specifically, with a 30 wt % HDDA cross-linker (A₇₀X₃₀P₀), surface features are largely inhibited from forming (e.g., Kinetically Trapped) and there is a smooth, glossy surface (blue outline, FIG. 7Ci, FIG. 7Cii). In FIG. 7Ci, features captured in the image are not actually topography; rather, they were confirmed to be present only below the surface near the substrate using microscope profilometry. In this high cross-linking scenario, a significant degree of kinetic trapping occurs as the network's increased stiffness limits stress relaxation and topographical evolution of the free interface. This Kinetically Trapped scenario is due to two factors associated with a higher cross-link density (here, 30 wt % cross-linker). First, highly cross-linked networks are more resistant to deformation by internal stresses and are thus unable to accommodate relaxations as well as softer materials. Second, oxygen diffusion is more limited in highly cross-linked systems, which reduces the depth at which radical quenching can occur and thus the magnitude and size of an associated gradient in properties. The impact of these two concurrent factors is obvious from the images and further captured in the wavelength and roughness (Ra) measurements of the PMMA free samples (FIG. 8A-FIG. 8C), as well as in water contact angle measurements where surface roughening leads to increased wettability (FIG. 9). Surface feature formation is suppressed, and the surface becomes smoother and smoother with increasing HDDA fraction as the network is unable to accommodate the relaxation mechanism of surface roughening.

### Quenching Dominated Copolymer Networks

When the cross-linking is reduced, e.g., the 5-10 wt % HDDA samples in FIG. 7A-FIG. 7C, the reaction kinetics are reduced (e.g., slower). Thus, the topographies that form are dominated by oxygen inhibition at the free resin surface, which results in a mechanical modulus mismatch due to radical scavenging (e.g., Quenching Dominated, FIG. 7B, FIG. 7C).

Observation of the AₐX_{b}P₀ resins after polymerization also reveals that Iₒ impacts the opacity of these materials; all formulations were transparent when cured at Iₒ=0.01 W/cm², whereas opacity was observed in several samples cured at Iₒ=0.1 W/cm², with this reduction in light transmission previously reported. Specifically, at the lower irradiation condition (Iₒ=0.01 W/cm²) opacity was most significant for the lowest HDDA fraction (e.g., A₉₅X₅P₀), and the level of opacity decreased with increasing HDDA content; at 30% HDDA fraction (A₇₀X₃₀P₀) the material was visibly transparent (Table 3). The opacity observed likely indicates phase separation of the two comonomers employed (AN and HDDA) at a domain size larger than the wavelength of the interacting visible light. Additionally, the proclivity for phase separation at lower irradiation intensities supports prior research on how Iₒ influences the phase separation mechanism, structure, and size in PIPS systems.

TABLE 3
Sample Transparency at End of Cure.

| | 0.01 W/cm² | 0.1 W/cm² |
|---|---|---|
| A₉₅X₅P₀ | 74% | 6% |
| A₉₀X₁₀P₀ | 82% | 29% |
| A₇₀X₃₀P₀ | 96% | 96% |

Opacity was calculated by taking grayscale images prior to and following curing of the samples on a black background, and the change in opacity was calculated using ImageJ to obtain average pixel brightness for the image of the sample.

These opacity variations are interesting when considering that with the low and mid range cross-link densities (5-10 wt % HDDA, Quenching Dominated), irradiation intensity also influences the scale of topographies that form (FIG. 8A-FIG. 8B). These topographies are stable, as long-term storage (2 years) of the samples reveals no significant changes in Ra (Table 4). Irradiation intensity has been shown to be effective as a direct means to alter the polymerization kinetics via the rate of initiation, and here two distinct intensities were utilized: Iₒ=0.1 W/cm² and Iₒ=0.01 W/cm². When employing the lower UV intensity (0.01 W/cm², upper row FIG. 7A-FIG. 7C), there is a lower rate of radical activation, which reduces the rate of initiation and thus the overall rate of polymerization (Rₚ). As such, the evolving polymer network has greater internal mobility, which allows for more equilibrium macromolecular states to be adopted prior to the end of the reaction or at a minimum prior to vitrification of the network (e.g., transition to a glassy state). On the other hand, increasing the UV intensity by an order of magnitude (0.1 W/cm², lower row, FIG. 7A-FIG. 7C) increases the concentration of reactive sites from cleaved initiator molecules, especially at the onset of polymerization. The rapid network formation at a higher irradiation intensity locks the developing polymer network into place sooner and reduces the time available to adopt an equilibrium-type state. If this change in Rₚ was the only factor at play, it might be expected that a similar feature-dampening effect that is observed as a function of cross-link density, e.g., surfaces becoming smoother as light intensity is systematically increased. However, this is not the case, which emphasizes that the opacity observations and potential phase separation of the two comonomer species influence the topography behavior.

TABLE 4
Stability of Sample Coating Surface Roughness
(samples cured at 0.1 W/cm²).

| | Ra Measured Immediately | Ra Measured After 2 |
|---|---|---|
| | Post cure (μm) | Years (μm) |
| A₉₅X₅P₀ | 59.0 ± 12.7 | 58.8 ± 15.8 |
| A₉₀X₁₀P₀ | 66.6 ± 22.4 | 62.3 ± 25.9 |
| A₇₀X₃₀P₀ | 21.2 ± 9.1 | 23.7 ± 7.7 |

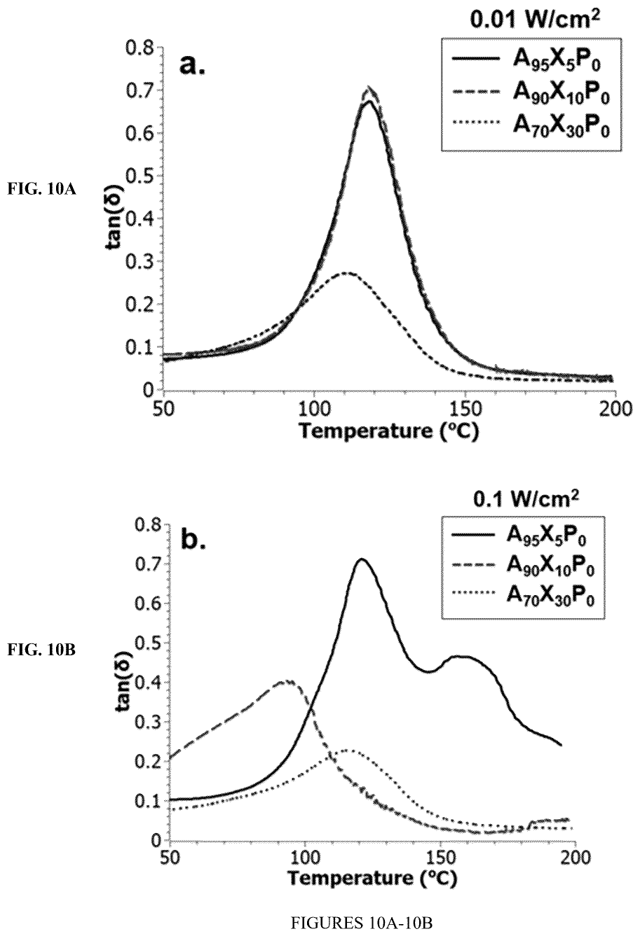

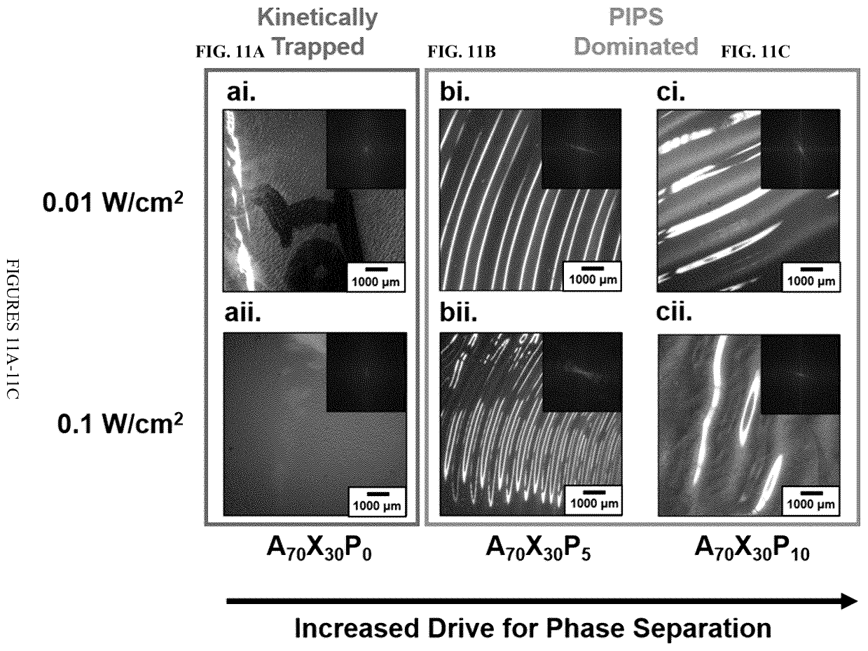

While the optical transparency of samples at 30% HDDA likely indicates the homogeneity of the formed network, there is the possibility of phase separation below the threshold of the wavelength of visible light. The thermal analysis enables the characterization of the bulk network to complement the optical observations and topographical characterizations. From thermal analysis, AₐX_{b}P₀ samples irradiated at 0.01 W/cm² presented a single, symmetric tan (8) profile, indicative of a well-mixed copolymer network (FIG. 10A, Table 5). The glass transition temperature (T_{g}), taken as the local maxima in the tan (8) profile, is shifted to a modestly lower temperature at the highest HDDA fraction (e.g., degree of cross-linking, A₇₀X₃₀P₀), this is expected as higher cross-linking can lead to lower overall C═C conversion and increased diffusional constraints during polymerization that limit the formation of a uniformly cross-linked network. This is further reflected in the increased broadening of the tan (8) peak with increasing HDDA fraction, indicating more significant local variations within the network as cross-linking increases. These findings are consistent with micro gel formation within systems with a high multifunctional monomer content, where localized regions of high cross-link density are interconnected among regions with lower cross-link density.

TABLE 5
Tan (δ) Peak Position and FWHM
for AₐX_{b}P₀ Samples at 0.01 W/cm²

| | T_{g} (° C.) | FWHM |
|---|---|---|
| A₉₅X₅P₀ | 118 | 26 |
| A₉₀X₁₀P₀ | 118 | 25 |
| A₇₀X₃₀P₀ | 110 | 36 |

The thermal analysis of the AₐX_{b}P₀ copolymer networks also confirms that opaque specimens cured with high UV irradiation (0.1 W/cm²) are indeed phase-separated networks as multiple tan (8) peaks are observed, indicative of domains with distinct thermal behavior within the samples (FIG. 10B, Table 6). This is most pronounced in the A₉₅X₅P₀ formulation, where one peak centered at 120° C. and another at 160° C. is observed. The lower temperature peak (centered at 120° C.) aligns with the singular peak observed when this sample is irradiated at 0.01 W/cm². This indicates that one of the formed domains behaves similarly to a well-mixed A₉₅X₅P₀ copolymer. The other visibly opaque specimen, mainly A₉₀X₁₀P₀, shows a dominant peak (~93° C.) and a significant shoulder (~59° C.). The significant shift in observed T_{g} values compared to A₉₅X₅P₀ reveals that the composition of the phase-separated domains that form in samples with more significant cross-linking is altered. The argument for phase separation of these resulting copolymer networks at high irradiation intensity is further supported by the peak overlap resulting from the multiple domains with relation to known miscibility limitations of poly(acrylonitrile) and its corresponding monomer as well as reduced solubility between poly(acrylonitrile) and HDDA. Lastly, the thermal analysis also confirms that 30 wt % HDDA formulation cured at 0.1 W/cm², which is transparent, is a well-mixed network as it yields a single, symmetric peak in the tan (8) profile. This emphasizes that both chemical composition and curing conditions contribute to the phase separation behavior of the copolymer network.

TABLE 6
tan(δ) Peak Position and FWHM
for AₐX_{b}P₀ Samples at 0.1 W/cm²

| | T_{g} (° C.) 1 | FWHM | T_{g} (° C.) 2 | FWHM 2 |
|---|---|---|---|---|
| A₉₅X₅P₀ | 120 | 88 | 160 | 37 |
| A₉₀X₁₀P₀ | 59 | 77 | 93 | 23 |
| A₇₀X₃₀P₀ | 116 | 36 | — | — |

Overall, in examining the copolymer resins, e.g., AₐX_{b}P₀ samples without PMMA, traditional wrinkling at lower irradiation intensities was confirmed, due to O₂-driven radical quenching. At the higher irradiation intensity, copolymer phase separation is observed to occur, yielding the dimple-like morphologies with more extreme feature definition, although they are still limited to expressing roughness at a single length scale (FIG. 7A, FIG. 7B). However, there is a threshold to how much cross-linker can be introduced before the polymer system becomes kinetically trapped (FIG. 7C). This reduction in surface feature presence is captured quantitatively in FIG. 8A and FIG. 8B, where the roughness of the A₇₀X₃₀P₀ samples approaches zero in both irradiation conditions.

### Example 8

### PIPS Dominated Resins as a Function of PMMA Loading

The other important mechanism at play in the complex surface topographies shown in FIG. 5A-FIG. 5C is phase separation resulting from the addition of an inert prepolymer. To confirm that PMMA-induced phase separation has the most significant impact on the PIPS Dominated topography in FIG. 5A-FIG. 5C, resins were designed where the impact of oxygen quenching on topography formation is heavily reduced. Specifically, this was achieved by using a network formulation that was designed to be Kinetically Trapped from the higher amounts of cross-linking in the network (e.g., A₇₀X₃₀P_{c} formulations, see FIG. 7C), and systematically varied the PMMA concentration. The A₇₀X₃₀P_{c} formulations were used to suppress wrinkling due to cross-linking gradients as identified in FIG. 7C, allowing for better probing of PIPS wrinkling alone. This design is motivated by previous works where roughening from PIPS arose from the formation of domains of differing densities and thus differences in shrinkage.

As highlighted by the microscope images in FIG. 11A-FIG. 11C, increased PMMA loading induces surface wrinkling in highly cross-linked resins that otherwise are glassy and smooth (e.g., Kinetically Trapped, FIG. 7C). The resulting PIPS Dominated wrinkle morphologies (FIG. 11B, FIG. 11C) have large wavelengths between 1 and 2 mm; a significant length scale relative to the 0.5 mm thickness of the resin coating. As opposed to the Quenching Dominated samples in FIG. 7A, FIG. 7B, here, the surface features are distinct wrinkles. The discrete waves in FIG. 11B, FIG. 11C manifest on a single length scale, however, when removing limitations of the Kinetically Trapped system through reducing the cross-linker fraction, mesoscale and microscale surface patterning is attainable as presented in FIG. 5B, FIG. 5C.

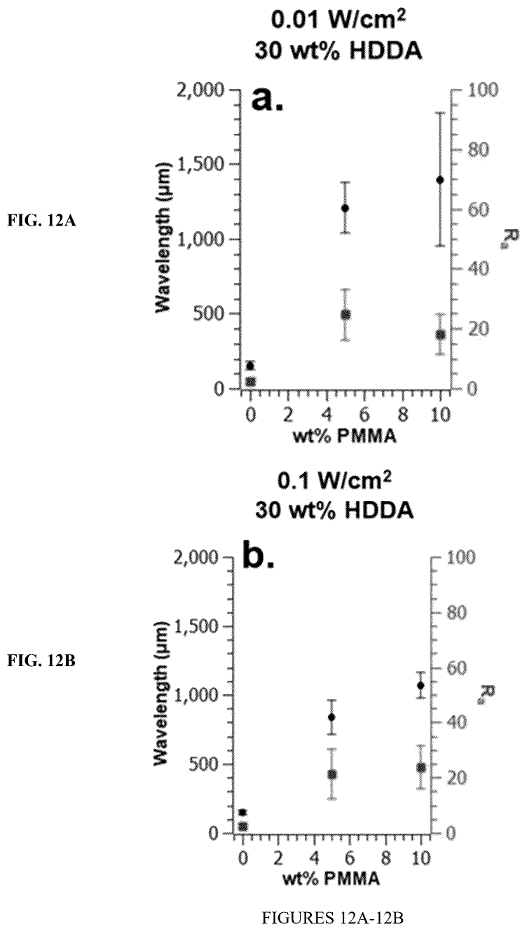

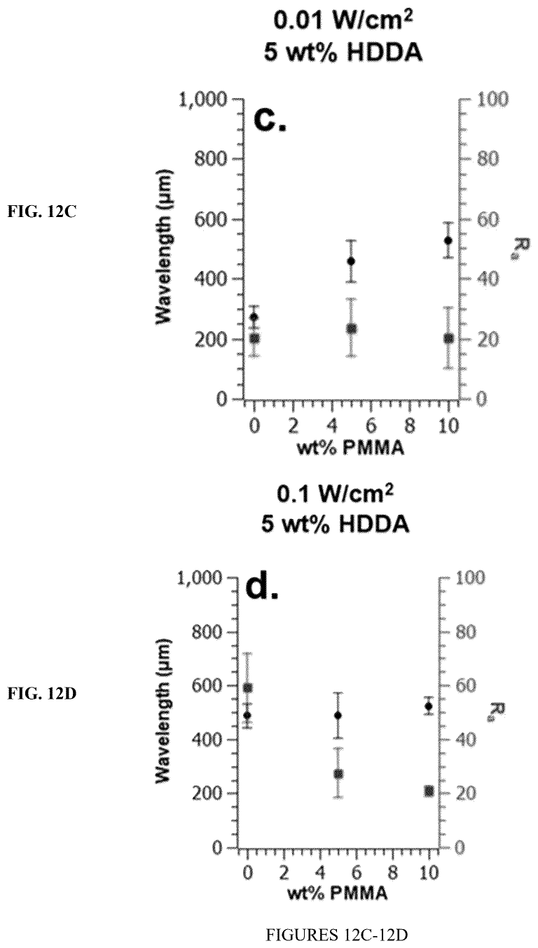

These distinct morphologies can be rationalized when considering the impact of the PMMA prepolymer on the resin kinetics and viscosity. Previous reports of the A₇₀X₃₀P_{c} system as well as similar PIPS systems utilizing prepolymers to trigger phase separation indicate that increased prepolymer fractions both decrease and delay R_{p,max} compared to a neat comonomer resin. This indicates that there is an enhanced period for the diffusion of phase domains. These kinetic variations are correlated to the resin viscosity. In the context of this system, previous work reports that the addition of PMMA increases the viscosity of the neat copolymer system from 0.66 to 1.61 mPa s at a loading of 5 wt %, and further increases to 5.64 mPa s at 10 wt %. With higher viscosities, there is greater resistance to surface relaxation for the network. This is reflected in the roughness analysis presented in FIG. 12A and FIG. 12B, where increased PMMA loading results in surface wrinkles with greater wavelengths for different cross-link densities and irradiation conditions.

Interestingly, wrinkle wavelength is comparable for PIPS Dominated resin formulations of equivalent cross-linking density, across the two UV intensities employed (FIG. 12A, FIG. 12B). However, this type of PIPS Dominated topography can be accessed in a system where the cross-linking is varied, e.g. 5 wt % HDDA with the A₉₅X₅P_{c} resins (FIG. 5B, FIG. 5C). Here, the quality of the topography is similar (large-scale wrinkles), but the scale of topographies varies. Specifically, comparing resins that are PIPS Dominated at 30 and 5 wt % cross-linking (FIG. 12A to FIG. 12C and FIG. 12B to FIG. 12D) emphasizes that wrinkles formed from resins with higher cross-link densities have larger wavelengths (roughly 2 times larger). In exploring the extreme cases possible with the AₐX_{b}P_{c} coatings, cross-link density impacted the final surface morphology by setting the kinetic environment of the developing polymer network. This allowed for tunability between single microscale roughness (low cross-linking, no PMMA; FIG. 5A), no roughness (high cross-linking, no PMMA; FIG. 11A) single mesoscale roughness (high crosslinking, PMMA PIPS; FIG. 11B, FIG. 11C), or combined mesoscale and microscale roughness (low cross-linking, PMMA PIPS; FIG. 5B, FIG. 5C).

### Example 9

### Use of Liquid Droplets in Formation of Compositions with Multiple Surface Textures

The instant example utilizes the formation of fluid interfaces in order to provide contrasting wettability on a single surface. For the instant example, resin formulation included one or more of vinyl acetate as the monomer, HDDA as the crosslinker, PDMS as the inert additive, and DMPA as the photo initiator. The various formulations used for the example are shown in Table 7.

TABLE 7
Full Compositions of Resins with Nomenclature -
Glass Coating Formulations

| | PDMS | VA | HDDA | DMPA |
|---|---|---|---|---|
| Formulation | (wt %) | (wt %) | (wt %) | (wt %) |
| V₈₅X₁₅P₀ | 0 | 82.02 | 14.48 | 3.50 |
| V₈₅X₁₅P_{0.33} | 0.32 | 81.75 | 14.3 | 3.50 |
| V₈₅X₁₅P_{0.66} | 0.65 | 81.47 | 14.38 | 3.50 |

First, glass molds were functionalized with 3-(Trimethoxysilyl) propyl methacrylate to enhance adhesion to the substrate. Resin deposition was made at a thin condition (i.e., T₁) using 5.5 mL of resin and a thick condition (i.e., T₂) using 13.5 mL of resin. Curing of the resin began by using 0.001 W/cm² to allow for slow kinetics of molecular diffusion, then curing in open air to promote surface wrinkling of the resin. At 45 seconds, water droplets were sprayed onto the reacting resin surface, randomly introducing new interfaces. Samples continued to cure at 0.001 W/cm² for 15 minutes, with a 20 minute post-cure at 0.01 W/cm². The UV source was turned off and side molds removed, resulting in a chemically and physically patterned polymeric surface.

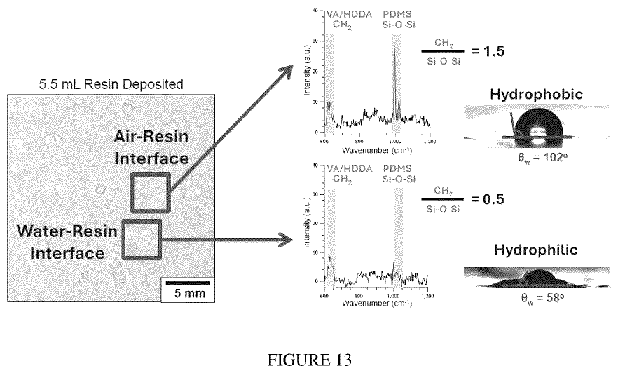

For macro domain separation, surface Raman spectroscopy was paired with water contact angle measurements in order to confirm chemical distributions due to interfaces present during curing. The analysis was able to compare the ratio between VA and HDDA network regions against PDMS signal intensity, as shown in FIG. 13.

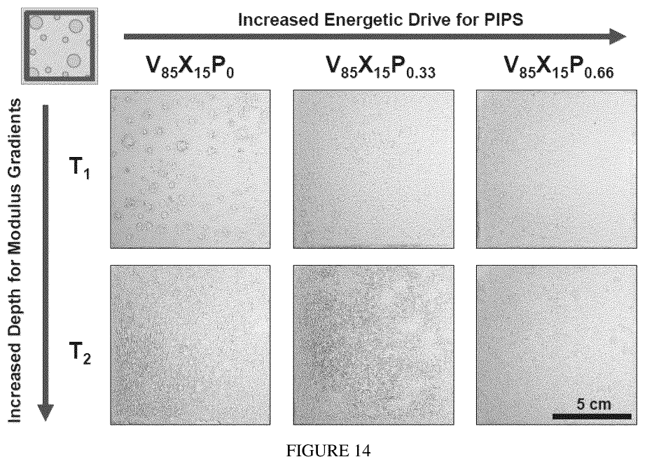

A diverse library of polymeric surfaces was generated through variation of both the inert PDMS chain concentration and the initial resin thickness. The application of water droplets applied during the UV curing process resulted in heterogeneous patterning across the available polymeric surface. FIG. 14 shows the various polymeric surfaces.

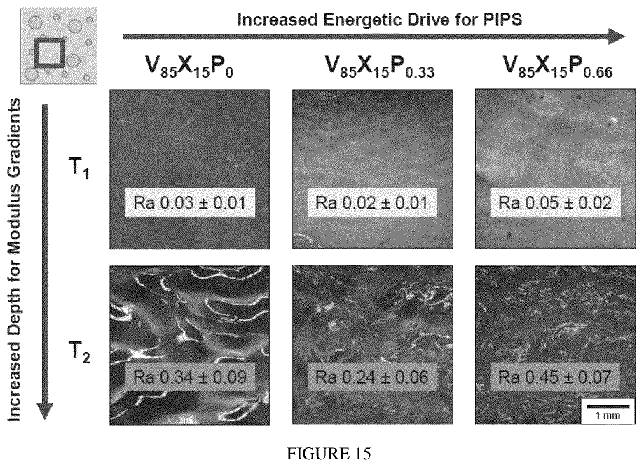

At the mesoscale level, application of PIPS was apparent according to the additional texture that was observed on the wavy bumps as the weight percentage of PDMS increased. With increased resin depth, roughness values (Ra) were increased an order of magnitude between formulations, as shown in FIG. 15.

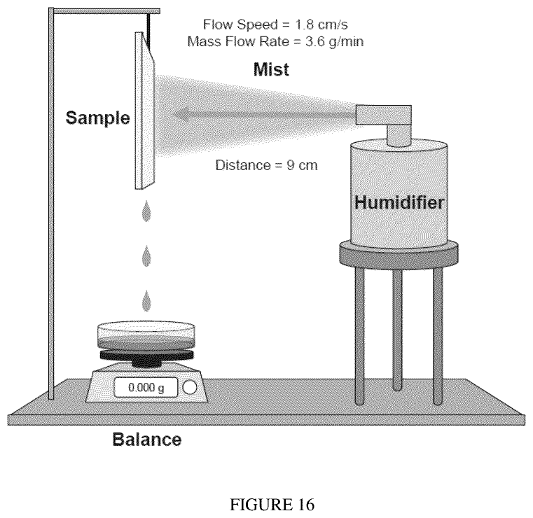

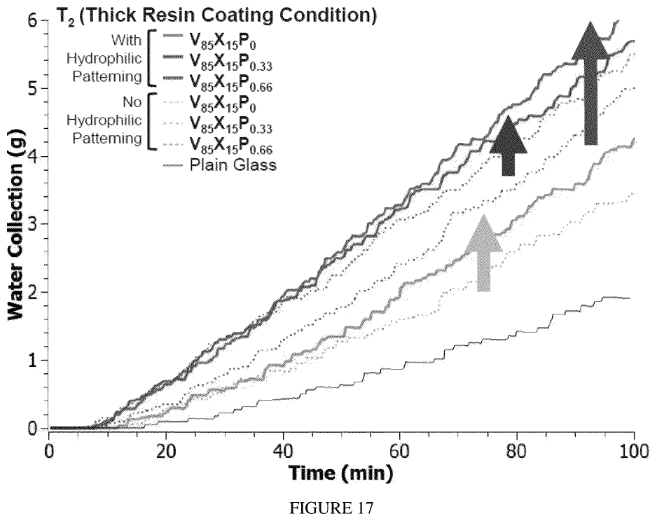

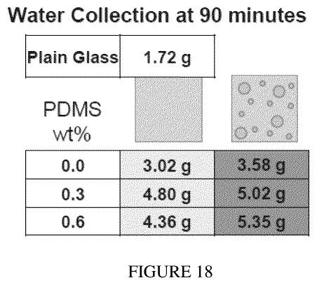

The formation of hydrophilic domains was observed to enhance water collection using the various samples. FIG. 16 shows the set up of sample evaluation via the collected water from humidifier mist for 2 hours, using a plain glass square as reference. The addition of PIPS to the polymer samples provided earlier start times for water to roll off and collect from the samples, with higher rates of collection. Further, samples that possessed hydrophilic patterning collected more water compared to pure resin counterparts. FIGS. 17 and 18 show the results of this analysis.

### Example 10

### Durability and Self-Cleaning Analysis of Compositions

The instant example analyzed the durability and self-cleaning behavior of the compositions comprising a coating of a polymeric composition. Coatings from three representative samples were tested for weathering endurance (V₈₅X₁₅P₀ with hydrophilic domains with T₂ thick coating condition, V₈₅X₁₅P_{0.33} with hydrophilic domains with T₂ thick coating condition, and V₈₅X₁₅P_{0.33} without hydrophilic domains with T₂ thick coating condition).

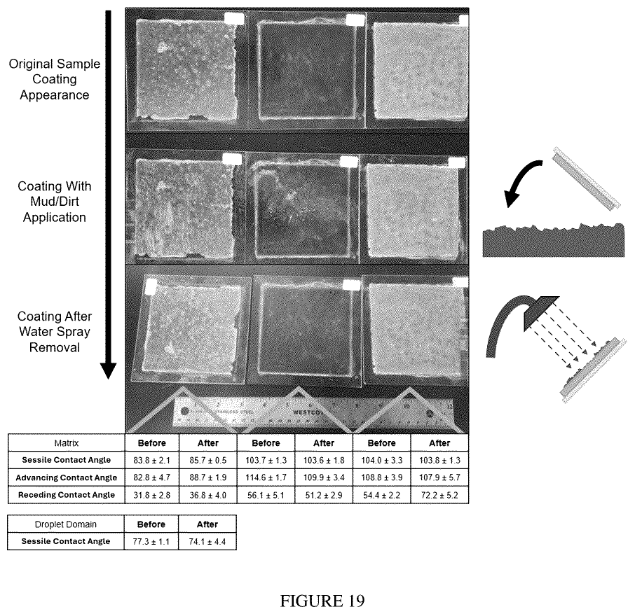

Optical images of the three coatings after completing UV curing, after sandy mud exposure, and after water faucet cleaning are presented in FIG. 19. Sandy mud exposure was accomplished through pushing face down coatings into the mud substrate by hand, waiting several seconds, then peeling the coating away from the mud. Removal of debris was accomplished through washing for approximately one minute under a sink faucet-no external scrubbing or other contact to the coating surface was employed for cleaning. Both sessile and advancing contact angles were measured with a goniometer to compare between pre and post weathering.

Minimal decline in surface properties were observed as a result of the weathering, indicating that these coatings can endure moderate outdoor debris accumulation conditions.

1. A composition comprising an outer surface comprising a polymeric composition,
wherein the outer surface comprises a first domain comprising a first texture property, and
wherein the outer surface comprises a second domain comprising a second texture property, wherein the polymeric composition is a photopolymer and wherein the polymeric composition is coated on the outer surface of the composition.

2. The composition of claim 1, wherein the first domain is hydrophilic and the second domain is hydrophobic.

3. The composition of claim 1, wherein the first texture property comprises surface roughness on the outer surface, wherein the surface roughness is present at an arithmetic roughness (Ra) value between about 5 μm and 100 μm.

4. The composition of claim 1, wherein the second texture property comprises a plurality of surface waves on the outer surface.

5. The composition of claim 1, wherein the first texture property is formed via liquid droplet guided domain formation.

6. The composition of claim 1, wherein the second texture property is formed via oxygen radical quenching.

7. The composition of claim 1, wherein the second texture property is formed via photoinduced phase separation (PIPS).

8. The composition of claim 1, wherein the polymeric composition comprises a monomer and a crosslinker.

9. The composition of claim 8, wherein the monomer comprises one radically polymerizable group.

10. The composition of claim 8, wherein the monomer is selected from the group consisting of acrylonitrile, vinyl acetate, vinyl butyl ether, methyl methacrylate, methacrylic acid, butyl acrylate, butyl methacrylate, ethyl methacrylate, and any combination thereof.

11. The composition of claim 8, wherein the crosslinker comprises two radically polymerizable groups.

12. The composition of claim 8, wherein the crosslinker is selected from the group consisting of 1,6 hexanediol diacrylate (HDDA), ethylene glycol diacrylate (EGDA), triethylene glycol diacrylate (TEGDA), 1,4 butane diol diacrylate (BDDA), diethylene glycol diacrylate (DEGDA), and any combination thereof.

13. The composition of claim 1, wherein the polymeric composition further comprises an inert additive, wherein the inert additive is hydrophobic.

14. The composition of claim 13, wherein the inert additive is poly(methyl methacrylate) (PMMA), poly(dimethyl siloxane) (PDMS), poly(butyl methacrylate) (PBMA), or any combination thereof.

15. The composition of claim 1, wherein the polymeric composition further comprises a photo initiator.

16. The composition of claim 15, wherein the photo initiator is 2,2-dimethoxy-2-phenylacetophenone (DMPA) or (2,4,6-Trimethylbenzoyl)-bis(4-methylphenyl)phosphine oxide (TMO).

17. A method of forming a plurality of domains on an outer surface of a composition, the method comprising the steps of
i) obtaining the composition, wherein the outer surface of the composition comprises a polymeric composition,
ii) applying a light source to the outer surface of the composition, and
iii) applying a plurality of liquid droplets to the outer surface of the composition,
wherein steps ii) and iii) form the plurality of domains on the outer surface of the composition.

18. The method of claim 17, wherein the plurality of domains comprises a first domain and a second domain, wherein the first domain is hydrophilic and the second domain is hydrophobic.

19. The method of claim 17, wherein the plurality of domains comprises a first domain and a second domain, wherein the first domain comprises a first texture property and the second domain comprises a second texture property.

20. The method of claim 19, wherein the first texture property comprises surface roughness on the outer surface and wherein the second texture property comprises a plurality of surface waves on the outer surface.
